(19) United States
(12) Patent Application Publication
(10) Pub. No.: US 2026/0195081 A1
(43) Pub. Date: Jul. 9, 2026

(54) PRINTER IMPOSING RESTRICTION ON POWER SUPPLY TO EXTERNAL DEVICE FROM POWER SUPPLY DEVICE

(71) Applicant: BROTHER KOGYO KABUSHIKI KAISHA, Nagoya (JP)

(72) Inventors: Yuki HIRAMATSU, Nukata (JP); Hiromasa TAKAHASHI, Gamagori (JP); Shuhei YAMAKAMI, Nagoya (JP); Takaaki NAKAO, Nagoya (JP); Guowei CHAI, Nagoya (JP); Atsushi FUJIOKA, Nagoya (JP)

(21) Appl. No.: 19/551,162

(22) Filed: Feb. 26, 2026

Related U.S. Application Data
(63) Continuation of application No. PCT/JP2024/038477, filed on Oct. 29, 2024.

(30) Foreign Application Priority Data
Nov. 29, 2023 (JP) 2023-201875

(51) Int. Cl. G06F 3/12; H02J 7/00

(52) U.S. Cl. CPC G06F 3/1229; G06F 3/1215; G06F 3/1221; H02J 7/855

(57) ABSTRACT

A printer includes a print engine, a power supply circuit, and a controller. The print engine is configured to perform a print operation in which an image is printed using power from a power supply device. The power supply circuit is configured to supply power to an external device from the power supply device. The controller performs an obtaining process including obtaining a parameter. The parameter indicates a power-supply load on the power supply device. The controller performs a first restricting process when the parameter is greater than or equal to a first threshold value. The first restricting process includes imposing a restriction on the power supplied to the external device from the power supply device via the power supply circuit.

### REFERENCE TO RELATED APPLICATIONS

This is a by-pass continuation application of International Application No. PCT/JP2024/038477 filed on October 29, 2024 which claims priority from Japanese Patent Application No. 2023-201875 filed on November 29, 2023. The entire contents of the International Application and the priority application are incorporated herein by reference.

### BACKGROUND ART

A known printer performs, for example, operations in a main function such as printing operations by using power from an AC adapter. The known printer includes a temperature detector, a temperature monitor, and a print condition setting unit. The temperature detector detects the surface temperature of the AC adapter. The temperature monitor monitors the surface temperature of the AC adapter detected by the temperature detector. When the surface temperature falls within a predetermined warning temperature range, the temperature monitor specifies a print control condition for reducing print load based on the surface temperature. The print condition setting unit outputs control information based on the specified print control condition to a print controller and a conveyance controller. The print controller and the conveyance controller perform print control based on the outputted control information.

### SUMMARY

It is conceivable that a function to supply power to an external device is added to the known printer described above, such a conceivable printer performs printing operations while also suppling power to the external device. In this case, since the load on the AC adapter increases, the conceivable printer reduces the load of printing operations by reducing the print speed for example. As a result, the printer would not be able to maintain its intended printing operations.

In view of the foregoing, it is an object of the present disclosure to provide a printer which has a power supply function to an external device and can maintain printing operations even when the load on the power source increases.

In order to attain the above and other objects, according to one aspect, the present disclosure provides a printer. The printer includes a print engine, a power supply circuit, and a controller. The print engine is configured to perform a print operation in which an image is printed using power from a power supply device. The power supply circuit is configured to supply power to an external device from the power supply device. The controller includes one or more processors. The controller is configured to perform: an obtaining process including: obtaining a parameter, the parameter indicating a power-supply load on the power supply device; and a first restricting process when the parameter is greater than or equal to a first threshold value, the first restricting process including: imposing a restriction on the power supplied to the external device from the power supply device via the power supply circuit.

In the above structure, the printer secures power for performing print operation by imposing restriction on the power to the external device according to the load on the power supply device. Accordingly, the printer can avoid reducing the load in the print operation. Therefore, the printer having the function of supplying power to the external device can maintain print operation even when the load on the power supply device increases.

### BRIEF DESCRIPTION OF DRAWINGS

FIG. 1 is an illustration of a system including a printer 1 and a tablet PC 5 connected to each other.

FIG. 2 is a block diagram illustrating an electric configuration of the printer 1.

FIG. 3 is a flowchart illustrating a main process.

FIG. 4 is a flowchart continued from FIG. 3 illustrating the main process.

FIG. 5 is an illustration of image data.

FIG. 6 is a table showing transitions of drive condition of the printer 1.

FIG. 7 is a diagram illustrating a relation between a parameter P and prescribed values Th1 to Th6.

FIG. 8 is another diagram illustrating a relation between the parameter P and prescribed values Th1 to Th6.

### DESCRIPTION

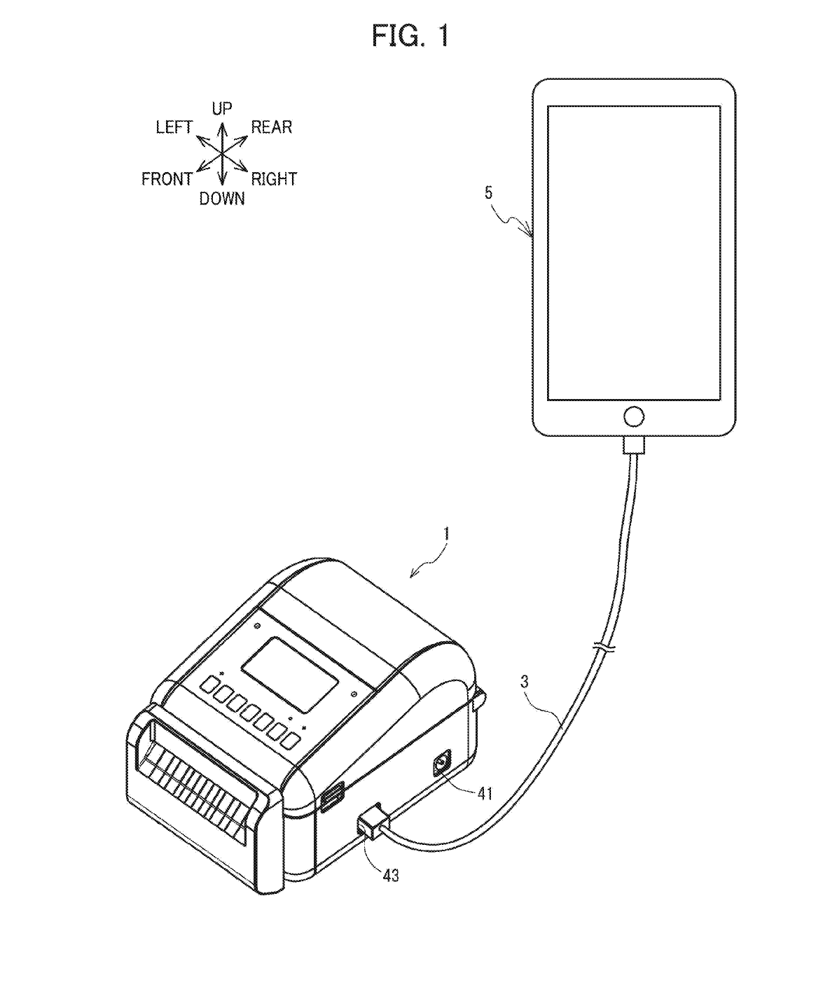

Hereinafter, an embodiment of the present disclosure will be described while referring to the accompanying drawings. The lower-right direction, upper-left direction, upper-right direction, lower-left direction, upward direction, and downward direction in FIG. 1 will be referred to as the right, left, rear, front, top, and bottom, respectively, of a printer 1.

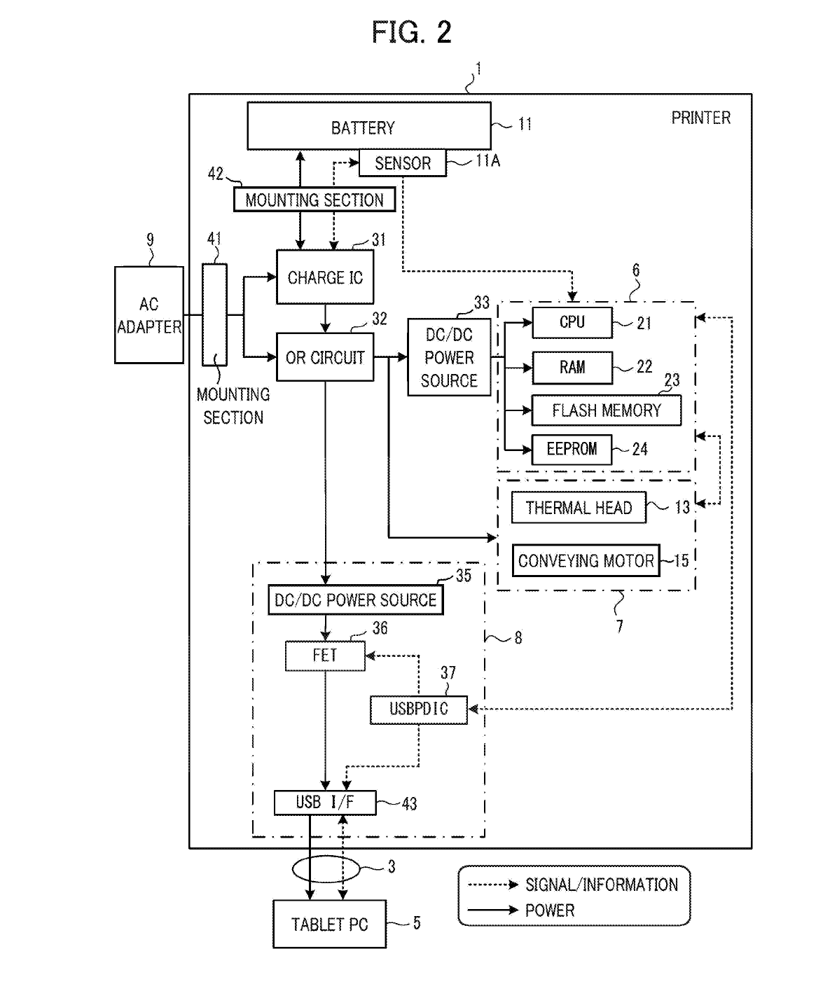

As illustrated in FIG. 1, the printer 1 is configured to be capable of printing on a print medium. The print medium includes a plurality of thermal labels continuously affixed to a long continuous sheet of backing paper, for example. The printer 1 can be driven by receiving power from an external power source connected to, for example, a commercial outlet (not shown). The external power source is an alternating current (AC) adapter 9 (see FIG. 2), for example. The AC adapter 9 is connected to a mounting section 41 positioned at the lower rear portion of the right side surface of the printer 1. Additionally, the printer 1 can be driven by receiving power from a battery 11 (see FIG. 2). The battery 11 is detachably mounted to a mounting section 42 (see FIG. 2) positioned at the interior of the printer 1. The battery 11 is a lithium-ion battery, for example.

An interface 43 is positioned at the lower front portion of the right side surface of the printer 1. The interface 43 is a USB interface (IF) in conformance with the USB Type-C (registered trademark) standard. “USB Type-C” is a registered U.S. trademark of USB Implementers Forum. A cable 3 is connected to the interface 43. The cable 3 includes a connector in conformance with the USB Type-C standard, and supports USB-PD (USB Power Delivery). For example, the cable 3 can transmit power corresponding to a current of a maximum of 5A, and transmit various types of information.

The printer 1 can be connected to, for example, an external device via the interface 43 and the cable 3. The external device is a tablet PC 5, for example. The tablet PC 5 includes an LCD (Liquid Crystal Display) touchscreen, for example. A user edits image data such as text and illustrations using the touchscreen, and transmits the image data to the printer 1 via the cable 3. The printer 1 prints content including characters, text, and illustrations, onto the medium based on image data received from the external device.

Additionally, the printer 1 can supply power to the tablet PC 5 in conformance with the USB-PD (USB Power Delivery) standard. Accordingly, the printer 1 can charge the tablet PC 5.

The electrical configuration of the printer 1 will be described with reference to FIG. 2. The printer 1 further includes a charge IC 31, an OR circuit 32, a digital circuit 6, a print engine 7, and a power supply unit 8. The charge IC 31 charges the battery 11 mounted to the mounting section 42 based on the power of the AC adapter 9. The battery 11 includes a sensor 11A capable of detecting battery temperature. The output result of the sensor 11A is transmitted to a CPU 21. The CPU 21 detects the temperature of the battery 11 from the received output result.

The OR circuit 32 switches the power supply path to the tablet PC 5 depending on whether the battery 11 and the AC adapter 9 are connected. For example, when the AC adapter 9 is connected but the battery 11 is not, the OR circuit 32 switches the power supply path so that power from the AC adapter 9 is supplied. When the battery 11 is connected but the AC adapter 9 is not, the OR circuit 32 switches the power supply path so that power from the battery 11 is supplied. When both the battery 11 and the AC adapter 9 are connected, the OR circuit 32 switches the power supply path so that, while power from the AC adapter 9 is supplied to the battery 11, power from the AC adapter 9 is also supplied to the digital circuit 6, the print engine 7, and the power supply unit 8. Note that the switching of the power supply path by the OR circuit 32 is automatically executed, but may be set by the user.

A DC/DC power source 33 converts the input voltage of the AC adapter 9 or the battery 11 into the output voltage for driving the digital circuit 6 (for example, 3.3 V). The digital circuit 6 includes the CPU 21, a RAM 22, a flash memory 23, and a EEPROM 24. The CPU 21 performs overall control of the printer 1. The CPU 21 is electrically connected to the RAM 22, the EEPROM 24, the flash memory 23, the print engine 7, and the power supply unit 8.

The RAM 22 temporarily stores various types of data, such as image data received from the tablet PC 5. Information such as printer settings and print history are stored in the EEPROM 24. Various programs including those to be executed by the CPU 21 for controlling the printer 1 are stored in the flash memory 23.

First to sixth prescribed values Th1 to Th6 to be used as threshold values in a main process (described later) are stored in the flash memory 23. The prescribed values Th1 to Th6 are, for example, values based on the rated current of the AC adapter 9, and may be set as appropriate. The first to sixth prescribed values Th1 to Th6 are mutually different values. For example, the relationship of first prescribed value Th1 < second prescribed value Th2 < third prescribed value Th3 is satisfied. The relationship of fourth prescribed value Th4 > fifth prescribed value Th5 > sixth prescribed value Th6 is satisfied. Additionally, the relationship of third prescribed value Th3 > fourth prescribed value Th4 is satisfied. The relationship of second prescribed value Th2 > fifth prescribed value Th5 is satisfied. The relationship of first prescribed value Th1 > sixth prescribed value Th6 is satisfied. Each of the prescribed values Th1 to Th6 will be described later in greater detail.

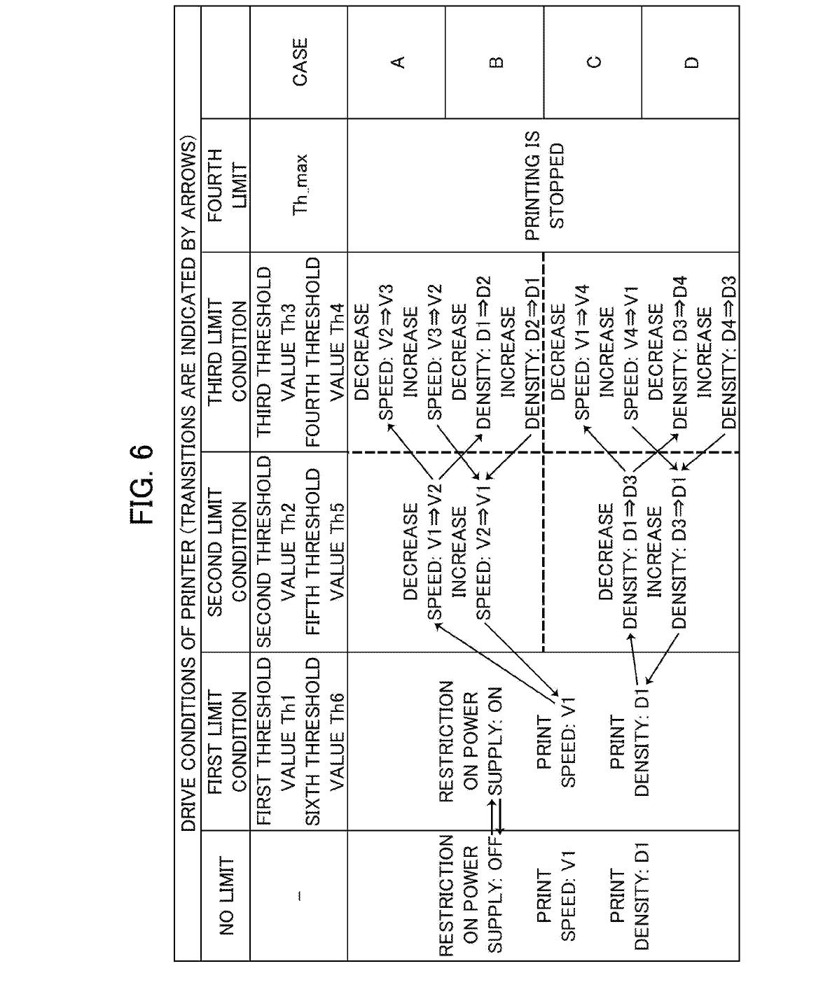

A table specifying drive conditions of the printer 1, as illustrated in FIG. 6, is stored in the flash memory 23. Each of the drive conditions of the printer 1 includes, for example, conditions of the print engine 7 and the power supply unit 8. Each of the drive conditions of the printer 1 includes a condition related to the print speed of the print engine 7 during printing operations, and a condition related to the print density of an image to be printed onto the medium. The condition related to the power supply unit 8 is a condition related to whether the power supply unit 8 is enabled to supply power to the external device. The condition of the print engine 7 and the power supply unit 8 is modified (updated) based on the relationships between a parameter P (described later) and each of the prescribed values Th1 to Th6. The drive conditions are categorized into cases A to D. Which of the cases A to D is to be executed may be automatically set by the printer 1 or may be set by the user. Each of the cases A to D will be described later in detail.

The power from the AC adapter 9 or the battery 11 is supplied to the print engine 7. The print engine 7 can perform printing onto the medium based on the power of the AC adapter 9 or the battery 11. The print engine 7 includes a thermal head 13, and a conveying motor 15. The thermal head 13 generates heat according to a signal from the CPU 21, and performs printing onto the medium. The conveying motor 15 drives a feed roller for feeding the medium. The CPU 21 performs printing onto the medium by controlling the thermal head 13 and the conveying motor 15.

The power supply unit 8 is a circuit that includes a DC/DC power source 35, a USBPDIC 37, a FET 36, and the interface 43. The DC/DC power source 35 converts the input voltage from the AC adapter 9 or the battery 11 to an output voltage suitable for supplying power to the tablet PC 5 (for example, 9 V or 5 V). The power from the power supply unit 8 is supplied to the tablet PC 5. The USBPDIC 37 can communicate with the CPU 21. The USBPDIC 37 can control the amount of output voltage from the DC/DC/power source. The USBPDIC 37 performs a negotiation in conformance with the USB-PD (USB Power Delivery) standard with the tablet PC 5 via the interface 43. The USBPDIC 37 controls the supply of power from the DC/DC power source 35 to the tablet PC 5 by switching the FET 36 between ON and OFF states. For example, when the FET 36 is turned on, power is supplied to the tablet PC 5 via the interface 43 and the cable 3. In other words, the power supply unit 8 can supply power based on the power of the AC adapter 9 or the battery 11 to the tablet PC 5. The power supply unit 8 is an example of the power supply circuit.

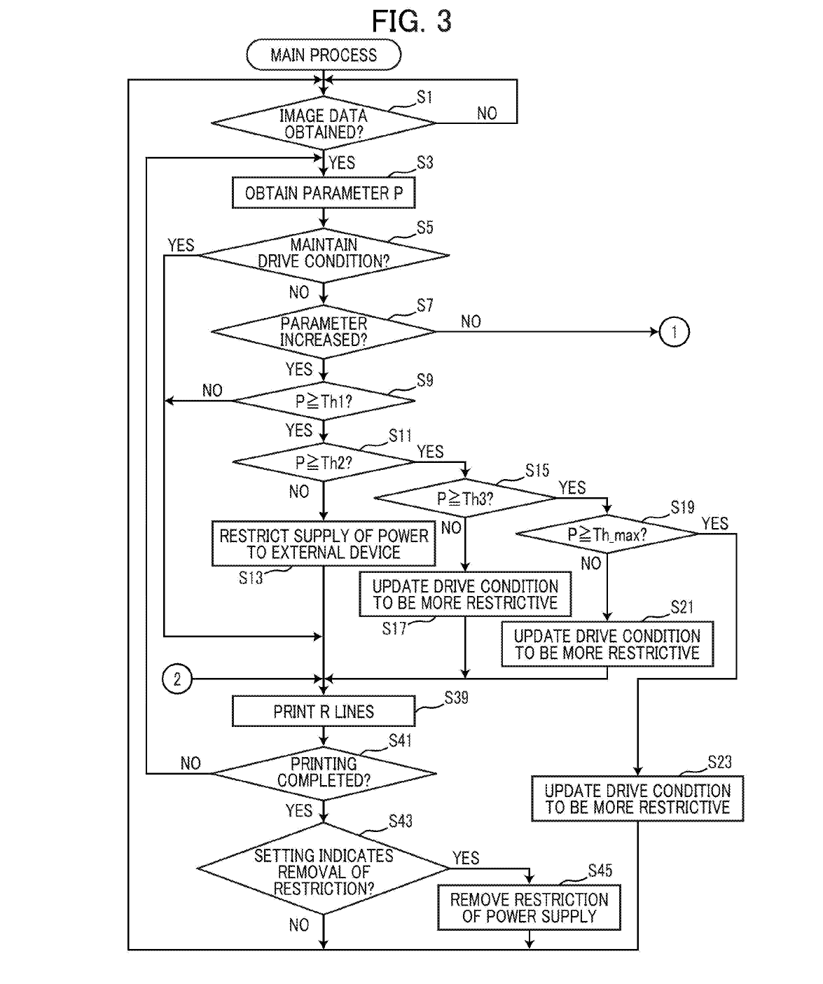

A main process will be described with reference to FIG. 3. Hereinafter, descriptions will be given on the assumption that the printer 1 is driven using the AC adapter 9 as the external power source. The battery 11 may or may not be mounted to the printer 1. The tablet PC 5 is connected to the printer 1 as the external device. When the power button of the printer 1 is pressed by the user, the CPU 21 executes programs read from the flash memory 23. Accordingly, the CPU 21 initiates the main process.

When the main process is initiated, in S1 the CPU 21 determines whether the image data has been obtained. When the image data is determined not to be obtained (S1: NO), the CPU 21 reverts the process and stands by. For example, the user edits the image data by operating the tablet PC 5, i.e., the external device, and transmits the image data to the printer 1.

When the image data is determined to be obtained (S1: YES), in S3 the CPU 21 obtains the parameter P. The parameter P indicates the amount of load on the AC adapter 9 when power is supplied from the AC adapter 9. The amount of load is, for example, the amount of current for driving the print engine 7. The parameter P is calculated by the CPU 21, for example.

An estimation of the parameter P will be described in detail with reference to FIG. 5. The image data is configured of N lines, for example. When calculating the parameter P, calculation is performed using, for example, data for R lines out of data for the N lines in the image data. Here, N and R are natural numbers. For example, when R = 3, that is, when the number of target lines is 3, calculation is performed based on the number of ON dots during printing of the 3 target lines. The 3 target lines are, for example, the first to third lines.

For example, the amount of current to be used when printing each line is 1A, 1.5A, and 0.2A, respectively. The total amount of current is 2.7A. When the amount of time for printing a single line is 100 µsec, the average amount of current per unit time for printing a single line is 2.7 / (100 × 3) = 0.009 A/µsec.

Then, the average amount of current per unit time is calculated in a similar manner based on the number of ON dots of the next 3 lines which were not included in the previous calculation. The next 3 target lines are, for example, the fourth to sixth lines. For example, assume the average amount of current per unit time is 0.04A/µsec. In this case, the total average value is (0.009 + 0.04) / 2 = 0.0245. The total average value corresponds to the parameter P. Thereafter, the value of parameter P is updated by calculating the total average value based on the average amount of current per unit time of the next 3 target lines. The updated parameter P is temporarily stored in the RAM 22.

In S5 the CPU 21 determines whether to maintain the drive condition of the printer 1 based on the obtained parameter P. For example, when no restriction is defined by any of the drive conditions of the printer 1, the drive condition of the printer 1 is maintained. Moreover, even when any restriction is imposed by the drive conditions of the printer 1, it can be assumed that the value of the obtained parameter P does not change across each of the prescribed values Th1 to Th6 that are the targets of the next limit change. In this case, the drive condition of the printer 1 is maintained regardless of variations of the parameter P. When the drive condition of the printer 1 is determined to be maintained (S5: YES), in S39 the CPU 21 performs printing for the R lines, based on which the parameter P has been obtained, while maintaining the drive condition of the printer 1.

For example, the CPU 21 drives the print engine 7 and the power supply unit 8 under the “no limit” condition among the drive conditions of the printer 1 illustrated in FIG. 6. The print speed of the print engine 7 is set as a first print speed V1, and the print density is set as a first print density D1. The first print speed V1 is the maximum speed, and the first print density is the most optimal density for printing. The first print density is set by the user, for example. The optimal density is, for example, the midpoint between the density of the lightest color and the density of darkest color. Furthermore, the power supply unit 8 also maintains the power supply restriction in the OFF state. As such, power can be supplied from the power supply unit 8 to the tablet PC 5.

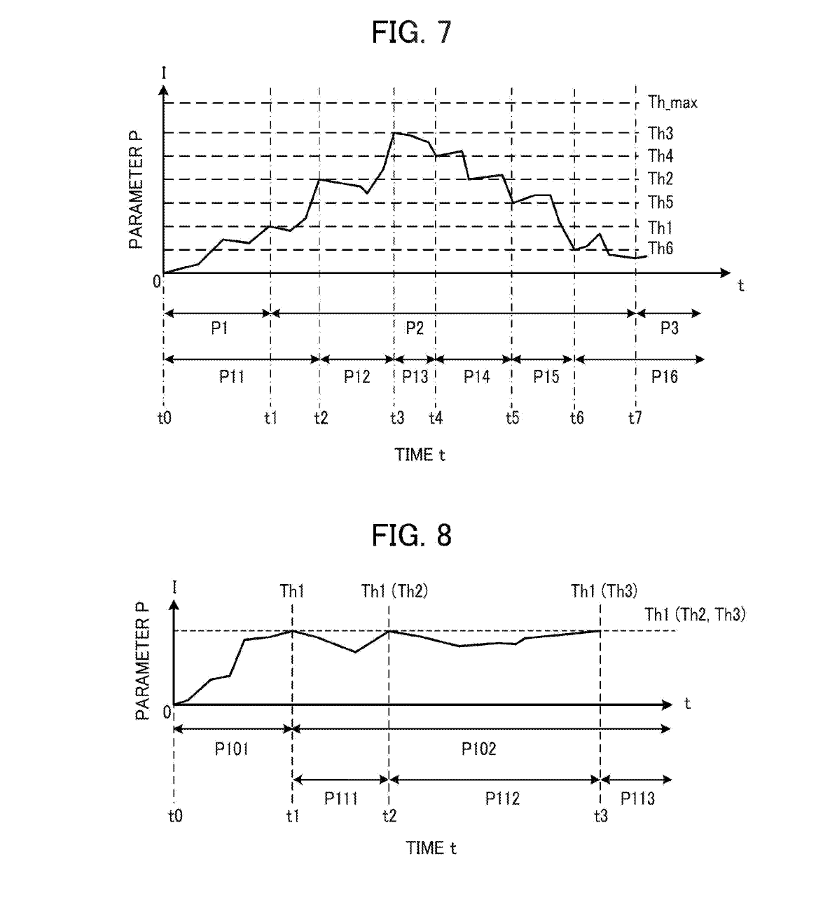

As illustrated in FIG. 7, printing is initiated by the print engine 7 at time t0. The parameter P changes with an upward trend during a section P1 between time t0 and time t1.

Each time printing of R lines is complete in S39, in S41 the CPU 21 determines whether printing based on the image data is completed. When printing based on the image data is determined not to be complete (S41: NO), the CPU 21 returns to S3, and obtains the parameter P using data for the next R lines.

On the other hand, when the drive condition of the printer 1 is determined not to be maintained (S5: NO), i.e., when the restriction based on the drive condition be tighten or loosen depending on the relationship between the parameter P and any one of the prescribed values Th1 to Th6, in S7 the CPU 21 determines whether the parameter P has increased. When the parameter P is determined to have increased (S7: YES), in S9 the CPU 21 determines whether the parameter P is greater than or equal to the first prescribed value Th1. When the parameter P is determined to be smaller than the first prescribed value Th1 (S9: NO), in S39 the CPU 21 performs printing of the R lines without changing the drive condition of the printer 1, so that the drive condition of the printer 1 is exceptionally maintained.

When the parameter P is determined to be greater than or equal to the first prescribed value Th1 (S9: YES), in S11 the CPU 21 determines whether the parameter P is greater than or equal to the second prescribed value Th2. When the parameter P is determined to be smaller than the second prescribed value Th2 (S11: NO), i.e., when Th1 ≤ P < Th2, in S13 the CPU 21 restricts the supply of power from the power supply unit 8 to the external device.

For example, the CPU 21 drives the print engine 7 and the power supply unit 8 under the “first limit” condition among the drive conditions of the printer 1 illustrated in FIG. 6. The supply of power from the power supply unit 8 to the external device is restricted. Restriction of power supply refers to the power supply unit 8 stopping the supply of power to the external device. In this case, no restrictions are imposed on the print engine 7. Therefore, the first print speed V1 and the first print density D1 are maintained.

In S39 the CPU 21 drives the print engine 7 and executes printing of the R lines under the “first limit” drive condition while restricting the supply of power to the external device. The CPU 21 then advances to S41.

For example, as illustrated in FIG. 7, during a section P11 between time t1 and time t2, the parameter P temporarily decreases but then changes with an upward trend. At time t2, the parameter P becomes greater than or equal to the second prescribed value Th2.

When the parameter P is determined to be greater than or equal to the second prescribed value Th2 (S11: YES), in S15 the CPU 21 determines whether the parameter P is greater than or equal to the third prescribed value Th3. When the parameter P is determined to be smaller than the third prescribed value Th3 (S15: NO), i.e., when Th3 ≤ P < Th3, in S17 the CPU 21 updates the drive condition of the print engine 7 to be more restrictive. In this case, the CPU 21 restricts the power consumed by the print engine 7 of the power supplied by the AC adapter 9.

For example, the CPU 21 drives the print engine 7 under the “second limit” condition, as a more restrictive drive condition among the drive conditions of the printer 1 illustrated in FIG. 6. For example, in cases A and B, by reducing the print speed to a second print speed V2, which is slower than the first print speed V1, the CPU 21 restricts the amount of power consumed by the print engine 7. On the other hand, in cases C and D, by executing printing operations at a third print density D3, which is lighter than the first print density D1, the CPU 21 restricts the amount of power consumed by the print engine 7. Note that the third print density D3 may be either the same as or different from a second print density D2 (described later) in cases A and B.

Subsequently to S17, in S39 the CPU 21 drives the print engine 7 and executes printing of the R lines under the “second limit” drive condition while restricting the supply of power to the external device. The CPU 21 then advances to S41.

For example, as illustrated in FIG. 7, during a section P12 between the time t2 and time t3, the parameter P temporarily decreases but then changes with an upward trend. At time t3, the parameter P reaches the third prescribed value Th3.

When the parameter P is determined to be greater than or equal to the third prescribed value Th3 (S15: YES), in S19 the CPU 21 determines whether the parameter P is greater than or equal to a maximum rating Th_max. When the parameter P is determined to be smaller than the maximum rating Th_max, in S21 the CPU 21 updates the drive condition of the printer 1 to be even more restrictive.

For example, the CPU 21 drives the print engine 7 under the “third limit” condition among the drive conditions of the printer 1 illustrated in FIG. 6. For example, in case A, by reducing the print speed to a third print speed V3, which is slower than the second print speed V2, the CPU 21 restricts the amount of power consumed by the print engine 7. In case B, by executing printing operations at the second print density D2, which is lighter than the first print density D1, the CPU 21 restricts the amount of power consumed by the print engine 7. In case C, by reducing the print speed to a fourth print speed V4, which is slower than the first print speed V1, the CPU 21 restricts the amount of power consumed by the print engine 7. In this case, the fourth print speed V4 may be either the same as or different to the second print speed V2 in case A. In case D, by executing printing operations at a fourth print density D4, which is lighter than the third print density D3, the CPU 21 restricts the amount of power consumed by the print engine 7.

In S39 the CPU 21 drives the print engine 7 and executes printing of the lines R under the “third limit” drive condition while restricting the supply of power to the external device. The CPU 21 then advances to S41.

For example, as illustrated in FIG. 7, the parameter P changes with a downward trend during a section P13 between time t3 and time t4. At time t4, the parameter P reaches the fourth prescribed value Th4.

On the other hand, when the parameter D is determined to be greater than or equal to the maximum rating Th_max (S19: YES), in S23 the CPU 21 updates the drive condition of the printer 1 to be even more restrictive. The CPU 21 then returns to S1.

For example, the “fourth limit” condition among the drive conditions of the printer 1 illustrated in FIG. 6 is applied as the more restrictive drive condition. In this case, it is determined that printing cannot be continued, and thus printing by the print engine 7 is stopped in any of the cases A to D. Note that in the example illustrated in FIG. 7, the parameter P does not reach the maximum rating Th_max.

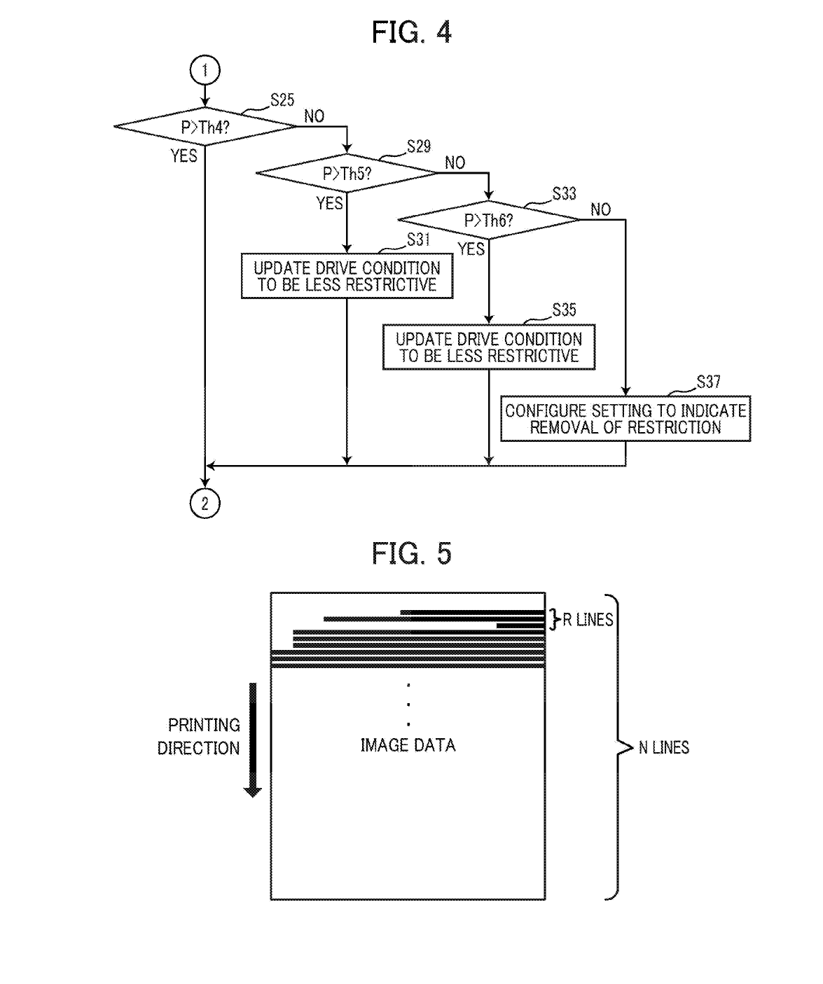

When the parameter P is determined not to be increasing, i.e., is determined to be decreasing (S7: NO), in S25 (FIG. 4) the CPU 21 determines whether the parameter P is greater than the fourth prescribed value Th4. When the parameter P is determined to be greater than the fourth prescribed value Th4 (S25: YES), in S39 the CPU 21 performs printing of the R lines with the current drive condition of the print engine 7, so that the drive condition of the printer 1 is exceptionally maintained. The CPU 21 then advances to S41.

When the parameter P is determined to be less than or equal to the fourth prescribed value Th4 (S25: NO), in S29 the CPU 21 determines whether the parameter P is less than or equal to the fifth prescribed value Th5. When the parameter P is determined to be greater than the fifth prescribed value Th5 (S29: YES), i.e., when Th4 ≥ P > Th5, in S31 the CPU 21 updates the drive condition to be more permissive (or to be less restrictive).

For example, the CPU 21 drives the print engine 7 under the “second limit” condition among the drive conditions of the printer 1 illustrated in FIG. 6. In case A, the CPU 21 increases the print speed from the third print speed V3 to the second print speed V2. In case B, the CPU 21 restores (reverts) the print density from the second print density D2 to the first print density D1. On the other hand, in case C, the CPU 21 increases the print speed from the fourth print speed V4 to the first print speed V1. In case D, the CPU 21 restores (reverts) the print density from the fourth print density D4 to the third print density D3.

Subsequently to S31, in S39 the CPU 21 drives the print engine 7 and executes printing of the R lines under the “second limit” drive condition while restricting the supply of power to the external device. The CPU 21 then advances to S41.

For example, as illustrated in FIG. 7, the parameter P changes in a downward trend while repeatedly increasing and decreasing during a section P14 between time t4 and time t5. At time t5, the parameter P reaches the fifth prescribed value Th5.

When the parameter P is determined to be less than or equal to the fifth prescribed value (S29: NO), in S33 the CPU 21 determines whether the parameter P is greater than the sixth prescribed value Th6. When the parameter P is determined to be greater than the sixth prescribed value Th6 (S33: YES), i.e., when Th5 ≥ P > Th6, in S35 the CPU 21 updates the drive condition to be more permissive (or to be less restrictive).

For example, the CPU 21 drives the print engine 7 under the “first limit” condition among the drive conditions of the printer 1 illustrated in FIG. 6. In cases A and B, the CPU 21 increases the print speed from the second print speed V2 to the first print speed V1. On the other hand, in cases C and D, the CPU 21 restores (reverts) the print density from the third print density D3 to the first print density D1.

In S39 the CPU 21 drives the print engine 7 and executes printing of the R lines under the “first limit” drive condition while restricting the supply of power to the external device. The CPU 21 then advances to S41.

For example, as illustrated in FIG. 7, the parameter P temporarily increases during a section P15 between time t5 and time t6, but then changes with a downward trend. At time t6, the parameter P reaches the sixth prescribed value Th6.

When the parameter P is determined to be less than or equal to the sixth prescribed value Th6 (S33: NO), in S37 the CPU 21 performs a process configuring a setting to indicate removal of the restriction on power supply from the power supply unit 8 to the external device. However, the CPU 21 does not immediately begin the supply of power to the external device by the power supply unit 8. In other words, in S39 the CPU 21 drives the print engine 7 and executes printing of the R lines while maintaining the “first limit” drive condition. The CPU 21 then advances to S41.

For example, as illustrated in FIG. 7, the parameter P temporarily increases during a section P16 between time t6 and time t7, but then changes with a downward trend. At time t7, printing by the print engine 7 is completed.

When printing based on the image data is determined to have been completed (S41: YES), in S43 the CPU 21 determines whether the setting indicating removal of restriction on power supply from the power supply unit 8 to the external device has been configured in S37. When it is determined that the setting to remove restriction of power supply from the power supply unit 8 to the external device has not been configured (S43: NO), the CPU 21 returns to S1 and stands by without removing the restriction of power supply.

On the other hand, when it is determined that the setting to remove restriction of power supply from the power supply unit 8 to the external device has been configured (S43: YES), i.e., when the process in S37 has been executed, in S45 the CPU 21 removes the restriction of power supply from the power supply unit 8 to the external device. In other words, when the parameter P becomes less than or equal to the sixth prescribed value Th6 following the restriction of the supply of power from the power supply unit 8 to the external device, and thereafter printing operations by the print engine 7 have been completed, the CPU 21 removes the restriction of power supply from the power supply unit 8 to the external device.

For example, as illustrated in FIG. 7, during a section P3 after time t7, power supply by the power supply unit 8 is performed. In other words, the restriction of power supply by the power supply unit 8 imposed in a section P2 between time t1 and time t7 are removed upon completion of printing.

The CPU 21 then returns to S1 and stands by.

As described above, the CPU 21 obtains the parameter P indicating the amount of load of the external power source when power is supplied from the external power source. When the obtained parameter P becomes greater than or equal to the first prescribed value Th1, the CPU 21 restricts the supply of power from the power supply unit 8 to the external device.

The printer 1 secures power for performing printing operations by restricting the supply of power to the external device according to the amount of load on the external power source. Accordingly, the printer 1 can avoid reducing the amount of load in the printing operation. Therefore, in a case where the printer 1 has the function of supplying power to the external device, the printer 1 can maintain printing operations even when the load on the external power supply increases.

When the obtained parameter P is greater than or equal to the second prescribed value Th2, the CPU 21 restricts the power consumed by the print engine 7 from the power supplied by the external power source. When the amount of load on the external power source further increases, by restricting the power consumed by the print engine 7, the printer 1 can maintain printing operations.

By reducing the print speed of the printing operations performed by the print engine 7 to the second print speed V2 slower than the first print speed V1, the CPU 21 restricts the amount of power consumed by the print engine 7. The printer 1 can maintain printing operations while reducing the load on the external power source by simple controls.

By reducing the print speed of the printing operations performed by the print engine 7 to the third print speed V3 slower than the second print speed V2, the CPU 21 restricts the amount of power consumed by the print engine 7. When the parameter P is greater than or equal to the third prescribed value Th3, by performing printing operations at the second print density D2 lighter than the first print density D1 during printing operations performed by the print engine 7, the CPU 21 restricts the amount of power consumed by the print engine 7. The printer 1 can maintain printing operations while reducing additional load on the external power source by reducing the print speed to the third print speed V3 or reducing the print density to the second print density D2.

When the amount of power consumed by the print engine 7 is restricted thereafter the parameter P becomes less than or equal to the fourth prescribed value Th4, the CPU 21 increases the print speed from the third print speed V3 to the second print speed V2. When the amount of power consumed by the print engine 7 is restricted and thereafter the parameter P becomes less than or equal to the fourth prescribed value Th4, the CPU 21 restores the print density from the second print density D2 to the first print density D1. When the amount of load on the external power source is reduced, the amount of power that can be consumed by the print engine 7 increases. In this case, the printer 1 performs printing operations by increasing the print speed to the second print speed V2 that is less restrictive than the third print speed V3, or by restoring the print density to the first print density D1. Therefore, the printer 1 can efficiently use the power of the external power source.

When the amount of power consumed by the print engine 7 is restricted and thereafter the parameter P becomes less than or equal to the fifth prescribed value Th5, the CPU 21 increases the print speed from the second print speed V2 to the first print speed V1. When the amount of load on the external power source is reduced, the amount of power that can be consumed by the print engine 7 increases. In this case, the printer 1 performs printing operations by increasing the print speed to the first print speed V1 that is less restrictive than the second print speed V2. Therefore, the printer 1 can efficiently use the power of the external power source.

In a case where the printing operation is currently performed by the print engine 7 at the first print density D1, the CPU 21 restricts the amount of power consumed by the print engine 7 by changing the print density to the third print density D3 lighter than the first print density D1. The printer 1 can maintain printing operations while reducing the load on the external power source by simple controls.

When the parameter P is greater than or equal to the third prescribed value Th3 while the printing operation is performed by the print engine 7 at the third print density D3, the CPU 21 restricts the amount of power consumed by changing the print density to the fourth print density D4 lighter than the third print density D3. Alternatively, in a case where the parameter P is greater than or equal to the third prescribed value Th3 while the printing operation is performed by the print engine 7 at the first print speed V1, the CPU 21 restricts the amount of power consumed by the print engine 7 by reducing the print speed to the fourth print speed V4 slower than the first print speed V1. The printer 1 can maintain printing operations while reducing additional load on the external power source by reducing the print speed to the fourth print speed V4 or reducing the print density to the fourth print density D4.

In a case where the amount of power consumed by the print engine 7 is restricted and thereafter the parameter P becomes less than or equal to the fourth prescribed value Th4, the CPU 21 restores the print density from the fourth print density D4 to the third print density D3. In a case where the amount of power consumed by the print engine 7 is restricted and thereafter the parameter P becomes less than or equal to the fourth prescribed value Th4, the CPU 21 increases the print speed from the fourth print speed V4 to the first print speed V1. In this case, the printer 1 performs printing operations by restoring the print density to the third print density D3 that is less restrictive than the fourth print density D4, or by increasing the print speed to the first print speed V1. Therefore, the printer 1 can efficiently use the power of the external power source.

In a case where the amount of power consumed by the print engine 7 is restricted and thereafter the parameter P becomes less than or equal to the fifth prescribed value Th5, the CPU 21 restores the print density from the third print density D3 to the first print density D1. When the amount of load on the external power source is reduced, the amount of power that can be consumed by the print engine 7 increases. In this case, the printer 1 performs printing operations by returning the print density to the first print density D1 that is less restrictive than the second print density D2. Therefore, the printer 1 can efficiently use the power of the external power source.

In a case where the supply of power from the power supply unit 8 to the external device is restricted, and then the parameter P becomes less than or equal to the sixth prescribed value Th6, and thereafter printing operations by the print engine 7 is completed, the CPU 21 removes the restriction of power supply from the power supply unit 8 to the external device. When the amount of load on the external power source is reduced, the amount of power that can be consumed by the print engine 7 increases. In this case, the printer 1 removes the restriction of power supply to the external device. Therefore, the printer 1 can efficiently use the power of the external power source. Additionally, since the printer 1 maintains the restriction on power supply to external devices until printing operations are completed, changes to the driving state of the printer 1 during printing can be reduced. Therefore, the printer 1 can maintain the print quality.

The first prescribed value Th1 and the sixth prescribed value Th6 are mutually different values. The third prescribed value Th3 and the fourth prescribed value Th4 are mutually different values. The second prescribed value Th2 and the fifth prescribed value Th5 are mutually different values. For example, if each of prescribed values Th1 to Th6 have the same value, it is conceivable that the parameter P will fluctuate in a short period of time around each of the prescribed values Th1 to Th6. In this case, for example, restrictions to the print speed and its removal will occur frequently, making printing operations of the printer 1 unstable. Therefore, by setting each of the prescribed values Th1 to Th6 as different values, the printer 1 can stably perform printing operations.

The external power source is the AC adapter 9. The printer 1 can maintain printing operations even when the load on the AC adapter 9 increases.

The CPU 21 estimates the parameter P based on the image data to be printed onto the medium by the print engine7. The CPU 21 obtains the estimated parameter P. Since the printer 1 estimates the parameter P, sensors for detecting the load on the external power source such as a temperature sensor may not be prepared additionally.

In the foregoing description, the CPU 21 is an example of the controller of the present disclosure. The AC adapter 9 is an example of the power supply device of the present disclosure. The tablet PC 5 is an example of the external device of the present disclosure. The step S3 executed by the CPU 21 is an example of the obtaining process of the present disclosure. The step S13 executed by the CPU 21 is an example of the first restricting process of the present disclosure. The step S17 executed by the CPU 21 is an example of the second restricting process of the present disclosure. The step S21 executed by the CPU 21 is an example of the third restricting process of the present disclosure. The step S21 executed by the CPU 21 is an example of the fourth restricting process of the present disclosure. The step S31 is an example of the accelerating process of the present disclosure. The step S31 executed by the CPU 21 is an example of the density reverting process of the present disclosure. The step S35 is an example of the accelerating process of the present disclosure. The step S35 executed by the CPU 21 is an example of the reverting process of the present disclosure. The step S45 executed by the CPU 21 is an example of the restriction removing process of the present disclosure. The step S3 executed by the CPU 21 is an example of the calculating process of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The technology disclosed in the above embodiment and its variations may be combined in any ways that do not result in inconsistencies. The printer 1 utilizes a direct thermal method but is not limited to this configuration, and may employ an inkjet method. The external device is the tablet PC 5 but is not limited to this configuration. For example, the external device may be a smartphone, or other devices such as a PC. The AC adapter 9 is used as the external power source, but is not limited to this configuration. For example, the external power source may be external batteries. The printer 1 may receive power from the external device in conformance with the USB-PD (USB Power Delivery) standard.

In the above embodiment, the first to sixth prescribed values Th1 to Th6 are mutually different values but is not limited to this configuration. At least one of the first to sixth prescribed values Th1 to Th6 may have the same value. For example, as illustrated in FIG. 8, each of the prescribed values Th1 to Th3 may have the same value. In this case, the printer 1 updates the drive condition of the printer 1 by, for example, simply using the first prescribed value Th1. Specifically, each time the parameter P reaches the first prescribed value Th1, the printer 1 updates the drive condition to be more restrictive.

At time t0, printing based on the image data is performed. The estimation of the parameter P with target R lines is sequentially performed. During a section P101 between time t0 to time t1, the parameter P increases. In this case, no restriction is imposed on the printing operation of the printer 1 based on the drive condition (“no limit”). At time t1, the parameter P reaches the first prescribed value Th1. In this case, power supply by the power supply unit 8 to the external device is restricted (“first limit”). Note that during a section P102 after time t1, power supply by the power supply unit 8 to the external device remains restricted. During a section P111 between time t1 and time t2, the parameter P temporarily decreases but then increases. At time t2, the parameter P again reaches the first prescribed value Th1. In this case, for example, the print speed of the print engine 7 is reduced from the first print speed V1 to the second print speed V2 (“second limit”). During a section P112 between time t2 and time t3, the parameter P temporarily decreases but then increases. At time t3, the parameter P again reaches the first prescribed value Th1. During a section P113 after time t3, the print speed of the print engine 7 is reduced from the second print speed V2 to the third print speed V3 (“third limit”), for example.

In the example illustrated in FIG. 8, once the drive condition becomes more restrictive, the drive condition restriction is not eased until printing is completed. However, the printer 1 may set each of the prescribed values Th4 to Th6 as in the above embodiment and relax the drive condition sequentially. Note that each of the prescribed values Th4 to Th6 may have the same value or have mutually different values. In this case, the prescribed value Th4 is less than the prescribed value Th1. Additionally, it is conceivable that the parameter P does not decrease even when the drive condition becomes more restrictive. In such a case, for example, the drive condition may incrementally impose tighter restriction each time a predetermined time has elapsed. Furthermore, the maximum rating Th_max may be set as in the above embodiment.

In the above embodiment, the first print speed V1 is the fastest print speed but is not limited to this configuration. For example, the first print seed V1 may be set appropriately as a speed between the fastest print speed and the slowest print speed. Additionally, in the above embodiment, the first print density D1 is the midpoint between the density of the lightest and the density of darkest colors but is not limited to this configuration. For example, the first print density D1 may be set appropriately as a point between the density of the lightest color and the density of the darkest color. Furthermore, the first to fourth print speed V1 to V4, and the first to fourth print density D1 to D4 may be set by the printer 1 or may be set by the user.

In the above embodiment, the supply of power from the power supply unit 8 is stopped when the parameter P becomes greater than or equal to the first prescribed value Th1 but is not limited to this configuration. For example, the CPU 21 may limit the amount of power that can be supplied by the power supply unit 8 in stages.

In the above embodiment, the parameter P is defined as the total average value based on the average amount of current but is not limited to this configuration. For example, the parameter P may be a value based on the heat temperature of the AC adapter 9. For example, the AC adapter 9 includes a sensor for measuring the temperature of the AC adapter 9. The CPU 21 obtains, from the sensor, the measurement result of the temperature of the AC adapter 9 as the parameter P. In this case, each of the prescribed values Th1 to Th6 may be set appropriately based on the rated temperature of the AC adapter 9. Since the temperature of the AC adapter 9 is directly detected by the sensor and the measurement result is used as the parameter P, the printer 1 can change the drive condition to be more restrictive at a more accurate time in comparison to when the load is estimated.

In the main process of the above embodiment, the printer 1 is driven by the power of the AC adapter 9 but is not limited to this configuration. In the main process, the printer 1 may, for example, be driven by the battery 11. In this case, each of the prescribed values Th1 to Th6 may be set appropriately based on the rated current of the battery 11. The printer 1 can maintain printing operations even when the load on the battery 11 increases.

In the case where the printer 1 is driven by the battery 11, instead of estimating the parameter P, the heat temperature of the battery 11 detected by the sensor 11A may be used as the parameter P, for example. In this case, each of the prescribed values Th1 to Th6 may be set appropriately based on the rated temperature of the battery 11.

In the above embodiment, the parameter P is estimated where R = 3 but is not limited to this configuration. The number of target lines R may be set as appropriate. Additionally, in the above embodiment, upon obtaining the parameter P for the three target lines, the parameter P for the next three target lines is calculated but is not limited to this configuration. For example, after calculating the parameter P for the first to third lines, the calculation of the parameter P for the second to fourth lines may be performed without considering the first line. In calculating the parameter P, data of each line may be repeatedly used. However, the parameter P may be alternatively defined in a manner that data of each line may be used once and is not repeatedly used.

In the above embodiment, the printer 1 performs printing by the print engine 7 while estimating the parameter P but is not limited to this configuration. For example, the parameter P may be estimated before printing. Printing by the print engine 7 may be performed after the estimation is completed.

In the above embodiment, power supply from the power supply unit 8 to the external device can be performed after the process of configuring the setting to remove the restriction of power supply from the power supply unit 8 to the external device in S37 is executed and printing is completed. However, the main process is not limited to this configuration. For example, power supply from the power supply unit 8 to the external device may be resumed upon execution of the configuring process of S37.

The USB PDIC 37, an ASIC, and an FPGA (Field Programmable Gate Array) may be used instead of the CPU 21 as a processor. The term “processor” encompasses both a single processor or a group of multiple processors located either locally or remotely working together or in a distributed fashion to collectively perform the tasks attributed to the “processor” described herein. One or more processors may be referred to as a controller. Each of the steps in the main process may be executed through distributed processing performed by a plurality of processors. The printer 1 may include other non-transitory storage media, such as a hard disk drive. The non-transitory storage mediums may be any storage medium capable of storing information regardless of the period for which the information is stored. The non-transitory storage media may not include transitory storage media such as conveyed signals.

The various programs may be downloaded from a server connected to a network (not shown), i.e., transmitted as transmission signals, and may be stored in a memory such as a hard disk drive, for example. In this case, the various programs may be stored in a non-transitory storage medium, such as a hard disk drive included in the server.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A printer comprising:
a print engine configured to perform a print operation in which an image is printed using power from a power supply device;
a power supply circuit configured to supply power to an external device from the power supply device; and
a controller including one or more processors, the controller being configured to perform:
an obtaining process including:
obtaining a parameter, the parameter indicating a power-supply load on the power supply device; and
a first restricting process when the parameter is greater than or equal to a first threshold value, the first restricting process including:
imposing a restriction on the power supplied to the external device from the power supply device via the power supply circuit.

2. The printer according to claim 1,
wherein the controller is configured to further perform:
a second restricting process when the parameter is greater than or equal to a second threshold value, the second threshold value being greater than or equal to the first threshold value, the second restricting process including:
imposing a restriction on power consumption of the print engine.

3. The printer according to claim 2,
wherein the imposing in the second restricting process includes:
decreasing a print speed of the print operation from a first speed to a second speed.

4. The printer according to claim 3,
wherein the controller is configured to perform:
either a third restricting process or a fourth restricting process when the parameter is greater than or equal to a third threshold value, the third threshold value being greater than or equal to the second threshold value,
wherein the third restricting process includes:
decreasing the print speed from the second speed to a third speed,
wherein the fourth restricting process includes:
decreasing a print density of the print operation from a first density to a second density.

5. The printer according to claim 4,
wherein the controller is configured to further perform:
an acceleration process when the parameter is less than or equal to a fourth threshold value after execution of the third restricting process, the fourth threshold value being less than or equal to the third threshold value, the acceleration process including:
increasing the print speed from the third speed to the second speed; and
a reverting process when the parameter is less than or equal to the fourth threshold value after execution of the fourth restricting process, the reverting process including:
increasing the print density from the second density to the first density.

6. The printer according to claim 5,
wherein the fourth threshold value is less than the third threshold value.

7. The printer according to claim 3,
wherein the controller is configured to further perform:
an acceleration process when the parameter is less than or equal to a third threshold value after execution of the second restricting process, the third threshold value being less than or equal to the second threshold value, the acceleration process including:
increasing the print speed from the second speed to the first speed.

8. The printer according to claim 7,
wherein the third threshold value is less than the second threshold value.

9. The printer according to claim 2,
wherein the imposing in the second restricting process includes:
decreasing a print density of the print operation from a first density to a second density.

10. The printer according to claim 9,
wherein the controller is configured to further perform:
either a third restricting process or a fourth restricting process when the parameter is greater than or equal to a third threshold value, the third threshold value being greater than or equal to the second threshold value,
wherein the third restricting process includes:
decreasing the print density from the second density to a third density,
wherein the fourth restricting process includes:
decreasing a print speed of the print operation from a first speed to a second speed.

11. The printer according to claim 10,
wherein the controller is configured to further perform:
a reverting process when the parameter is less than or equal to a fourth threshold value after execution of the third restricting process, the fourth threshold value being less than or equal to the third threshold value, the reverting process including:
increasing the print density from the third density to the second density; and
an acceleration process when the parameter is less than or equal to the fourth threshold value after execution of the fourth restricting process, the acceleration process including:
increasing the print speed from the second speed to the first speed.

12. The printer according to claim 11,
wherein the fourth threshold value is less than the third threshold value.

13. The printer according to claim 9,
wherein the controller is configured to further perform:
a reverting process when the parameter is less than or equal to a third threshold value after execution of the second restricting process, the third threshold value being less than or equal to the second threshold value, the reverting process including:
increasing the print density from the second density to the first density.

14. The printer according to claim 13,
wherein the third threshold value is less than the second threshold value.

15. The printer according to claim 2,
wherein the controller is configured to further perform:
a restriction removing process when the parameter is less than or equal to a third threshold value after execution of the first restricting process, and thereafter the print operation is completed, the third threshold value being less than or equal to the first threshold value, the restriction removing process including:
removing the restriction imposed on the power supplied to the external device from the power supply device via the power supply circuit.

16. The printer according to claim 15,
wherein the third threshold value is less than the first threshold value.

17. The printer according to claim 1,
wherein the power supply device is an alternating current (AC) adapter.

18. The printer according to claim 1,
wherein the power supply device is a battery.

19. The printer according to claim 1,
wherein the controller is configured to further perform:
a calculating process including:
calculating the parameter based on image data representing the image,
wherein the obtaining in the obtaining process obtains the parameter calculated in the calculating process.

20. The printer according to claim 1,
wherein the parameter is based on a measured temperature of the power supply device.
